(19) United States
(12) Patent Application Publication
(10) Pub. No.: US 2025/0297644 A1
(43) Pub. Date: Sep. 25, 2025

(54) BALL BEARING

(71) Applicant: NTN CORPORATION, OSAKA (JP)

(72) Inventors: Tatsuhiko OGASAWARA, Kuwana (JP); Wenwei WU, Kuwana (JP)

(73) Assignee: NTN CORPORATION, OSAKA (JP)

(21) Appl. No.: 19/228,089

(22) Filed: Jun. 4, 2025

Related U.S. Application Data
(63) Continuation of application No. PCT/JP2023/043428, filed on Dec. 5, 2023.

(30) Foreign Application Priority Data
Dec. 7, 2022 (JP) 2022-195884
Mar. 13, 2023 (JP) 2023-038531

(51) Int. Cl. F16C 33/38; F16C 19/06

(52) U.S. Cl. CPC F16C 33/3887; F16C 19/06

(57) ABSTRACT

A deep groove ball bearing includes: an inner ring; an outer ring; balls interposed between the inner ring and the outer ring; and a corrugate steel plate retainer of a rolling element-guided type for retaining the balls. Each of cross sections in a circumferential direction and a radial direction which passes through the deepest portion of a pocket of the corrugate steel plate retainer is an arc-shaped curved surface. A contact point between the pocket and the ball on the cross section in the radial direction of the corrugate steel plate retainer is positioned in a retainer pocket surface. Further, a curvature radius of the retainer pocket surface in the radial direction is equal to or less than a curvature radius of the retainer pocket surface in the circumferential direction.

### CROSS REFERENCE TO THE RELATED APPLICATION

This application is a continuation application, under 35 U.S.C. § 111 (a) of international patent application No. PCT/JP2023/043428, filed Dec. 5, 2023, which claims priority to Japanese patent application No. 2022-195884 filed Dec. 7, 2022 and Japanese patent application No. 2023-038531 filed Mar. 13, 2023, the entire disclosures of all of which are herein incorporated by reference as a part of this application.

### BACKGROUND OF THE INVENTION

### Field of the Invention

The present invention relates to a ball bearing used for industrial machinery such as, for example, an electric motor or a compressor, in particular, to a ball bearing that can prevent malfunction of a retainer when misalignment occurs in the ball bearing.

### Description of Related Art

Various types of ball bearings used for industrial machinery are disclosed.

Patent Document 1 discloses a ball bearing including a retainer guided to an inner peripheral surface of an outer ring groove shoulder or an outer peripheral surface of an inner ring groove shoulder. The ball bearing can prevent malfunction of the retainer even when misalignment occurs between an inner ring and an outer ring of the ball bearing by satisfying the relational expressions, 0.04 Dw<δc and Cg<δr, between a maximum displacement &c in a circumferential direction and a maximum displacement δr in a radial direction of a rolling element in a retainer pocket, a diameter Dw of the rolling element, and a diameter guide clearance Cg between the retainer and a bearing ring.

Patent Document 2 discloses a ball bearing including a retainer in which a retainer pocket surface has a cylindrical shape to improve durability of the retainer by relaxing the concentration of interference force between a rolling element and the retainer when misalignment occurs between an inner ring and an outer ring of the ball bearing.

### RELATED DOCUMENT

### Patent Document

[Patent Document 1] JP Laid-open Patent Publication No. 2012-149733
[Patent Document 2] JP Laid-open Patent Publication No. 2008-281065

Both the ball bearings disclosed in Patent Documents 1 and 2 relieve a load applied from the rolling element to the retainer even when misalignment occurs between the inner ring and the outer ring of the ball bearing, thereby preventing malfunction of the retainer.

In the ball bearing disclosed in Patent Document 1, the retainer is guided by the inner peripheral surface of the outer ring groove shoulder or the outer peripheral surface of the inner ring groove shoulder, and is, hereinafter, referred to as a “retainer of a bearing ring guided type. In the ball bearing including the retainer of the bearing ring guided type, a slide occurs between the retainer and a guide surface of the bearing ring. Therefore, there is a possibility that friction, wear and heating between the retainer and the guide surface of the bearing ring may increase under a severe condition such as poor lubrication.

In the ball bearing disclosed in Patent Document 2, the retainer pocket surface has a cylindrical shape to prevent the retainer from being deformed in the radial direction due to lead-lag of the rolling element caused by misalignment, thereby avoiding excessive interference force between the rolling element and the retainer. However, since the retainer pocket surface has a cylindrical shape, a contact area between the spherical rolling element and the pocket surface is narrower than that of a typical spherical pocket surface, and accordingly a contact surface pressure is high. Therefore, there is a possibility that the retainer may be damaged.

Further, in Patent Document 2, under an using condition with misalignment, due to an increased displacement of the retainer, the retainer may come into contact with the outer ring groove shoulder and the inner ring groove shoulder, which generates a contact load. Therefore, there is a possibility of malfunction of the retainer.

### SUMMARY OF THE INVENTION

An object of the present invention is to provide a ball bearing that can relax interference force between a rolling element and a retainer due to lead-lag of the rolling element caused by misalignment between an inner ring and an outer ring and can stabilize a behavior of the retainer.

A ball bearing according to the present invention includes: an inner ring; an outer ring; rolling elements interposed between the inner ring and the outer ring; and a corrugate retainer of a rolling element-guided type for retaining the rolling elements. Each of cross sections in a circumferential direction and a radial direction which passes through the deepest portion of a pocket of the retainer is an arc-shaped curved surface. A contact point between the pocket and the rolling element on the cross section in the radial direction of the retainer is positioned in a retainer pocket surface. Further, a curvature radius of the retainer pocket surface in the radial direction is equal to or less than a curvature radius of the retainer pocket surface in the circumferential direction.

According to this configuration, the contact point between the pocket and the rolling element on the cross section in the radial direction of the corrugate steel plate retainer of the rolling element-guided type is positioned in the retainer pocket surface. In addition, the curvature radius of the retainer pocket surface in the radial direction is equal to or less than the curvature radius of the retainer pocket surface in the circumferential direction. Accordingly, even when misalignment occurs between the inner ring and the outer ring, it is possible to secure the allowable amount of movement of the rolling element in the retainer pocket in the circumferential direction which is sufficient to allow lead-lag of the rolling element and to suppress the amount of movement in the radial direction of the retainer. Therefore, it is possible to relax interference force between the retainer and the rolling element due to lead-lag of the rolling element caused by misalignment between the inner ring and the outer ring and to stabilize a behavior of the retainer.

For the retainer and the rolling element, the equations below may be satisfied.

$$[ Math 1 ]$$

$$( \begin{matrix}\frac{{R}_{R} \sqrt{{( {R}_{R} - r )}^{2} - {( {R}_{R} - d )}^{2}}}{( {R}_{R} - r )} ) \leq h \\ {R}_{R} \leq {R}_{C}\end{matrix}$$

r: radius of the rolling element
R_{C}: curvature radius of the retainer pocket surface in the circumferential direction
R_{R}: curvature radius of the retainer pocket surface in the radial direction
d: depth of the retainer pocket
h: width on one side of the retainer, which is a width from the deepest point of the retainer pocket to the outer or inner edges of the retainer pocket at an inner side in the radial direction)

According to this configuration, it is possible to relax interference force between the rolling element and the retainer due to lead-lag of the rolling element caused by misalignment and to suppress collision energy generated between the retainer and the rolling element under conditions with vibration and impact. Accordingly, it is possible to reduce repeated stress applied to the retainer due to lead-lag of the rolling element and to prevent fatigue breakdown of the retainer, thereby providing a ball bearing including a retainer having high reliability. In addition, it is possible to prevent vibration and noise caused by an instable behavior of the retainer.

The ball bearing may be a deep groove ball bearing used for industrial machinery. In this case, for example, a deep groove ball bearing having high reliability that generates less vibration and noise can be applied to industrial machinery such as an electric motor or a compressor.

Herein, in a servo motor or a generator with low-speed rotation, a deep groove ball bearing with a steel plate retainer manufactured at a relatively low cost. However, a steel plate wears more easily and is heavier than a resin. This causes early wear of the steel plate retainer and high temperature rising. Therefore, the steel plate retainer is not adopted to a servomotor or a generator with medium- or high-speed rotation.

In prior art described in JP Laid-open Patent Publication Nos. 2017-172749 and 2018-162875, the resin coating film of resin composition such as fluororesin and the solid lubricant layer are formed on a retainer pocket sliding with a rolling element. Accordingly, it is possible to reduce wear of the retainer pocket and to suppress torque increase and temperature increase.

The above prior art is effective to reduce pocket wear and to suppress torque increase and temperature increase. However, since a process of forming the resin coating film on a pocket surface to a pressed product of an original steel plate retainer, manufacturing cost is significantly high. Therefore, the retainer disclosed in the above prior art is not adopted to a servomotor or a generator.

A ball bearing according to a second configuration of the present invention includes: an inner ring; an outer ring; balls as a plurality of rolling elements interposed between the inner ring and the outer ring; and a corrugate retainer of a rolling element-guided type for retaining the balls. In addition, the below expression is satisfied.

$$[ Math 2 ]$$

$$\frac{( S - H ) \times ( R + S )}{( {S}^{2} - {R}^{2} )} < \frac{\sqrt{2}}{2}$$

H: depth of the pocket of the corrugate retainer
S: curvature radius of the pocket of the corrugate retainer
R: radius of the ball

In this description, a ball bearing as a rolling bearing may be referred to as a bearing, and a corrugate retainer may be referred as a retainer.

The corrugate retainer rotates, being pressed to the rolling element. A component force of the retainer rotation of a pressing load F is a retainer guide load. When an angle that comes into contact with the retainer pocket of the rolling element is defined as a contact angle θ, the retainer guide load is 2F cos θ. A component force in an axial direction of the pressing load F is a load to open the retainer held by a tack to the axial direction. The magnitude of the load is 2F sin θ.

During bearing rotation, the pressing load F from the rolling element to the corrugate retainer is determined by a rolling element load and a rolling friction coefficient. The pressing load F is constant unless the use condition is changed.

According to the above load analysis, for the same bearing under the similar use condition, the pressing force from the rolling element to the retainer is constant. Therefore, the contact angle θ between the rolling element and the pocket is the only factor to distribute the pressing load F to a driving force F cos θ of the retainer and a load F sin θ in the axial direction.

When the corrugate retainer receives a guide load F cos θ in a rotational direction from the rolling element, the retainer and the rolling element rotate together. Since the retainer cannot be freed to the axial direction from the load F sin θ in the axial direction from the rolling element, the retainer wears significantly. Therefore, the load F sin θ in the axial direction is a main cause of pocket wear. To reduce pocket wear, the pocket shape of the retainer is optimized so that the contact angle θ is less than 45 degrees to lessen the load F sin θ in the axial direction.

In a prescribed rotation test in which a deep groove ball bearing for industrial machinery is used as the ball bearing which is the rolling baring, when the contact angle θ is less than 45 degrees, pocket wear did not occur, and it was possible to suppress temperature increase as compared with a comparative example. When the contact angle θ is 45 degrees or more, pocket wear occurred, and vibration during rotation was stronger than in the case where the contact angle θ is less than 45 degrees.

According to this configuration, it is possible to obtain the above advantageous effects by only optimizing the pocket shape of the retainer. Therefore, as compared with the conventional technology in which the resin coating film is formed on the pocket surface, it is possible to reduce manufacturing costs, to reduce wear and to suppress rotational torque and temperature increase.

The corrugate retainer may satisfy the equation below.

$$[ Math 3 ]$$

$$Bt \geq \frac{Cr}{9}$$

B: width of the retainer
t: thickness of the retainer
Cr: basic dynamic rated load

According this configuration, it is possible to obtain necessary strength for the corrugate retainer by making a cross sectional area of the retainer calculated by multiplying a width of the retainer by a thickness of the retainer greater than a set value.

The corrugate retainer may satisfy the equation below.

$$[ Math 4 ]$$

$$\frac{( {D}_{1} - {D}_{2} )}{2} - 1 \geq B \geq 2 \times \sqrt{{S}^{2} - {( S - ( H - R ) )}^{2}}$$

D₁: inner diameter of the outer ring
D₂: outer diameter of the inner ring
B: width of the retainer
H: depth of the pocket of the corrugate retainer
S: curvature radius of the pocket of the corrugate retainer
R: radius of the ball

According to this configuration, the width of the retainer is set within a set range on the premise of satisfying the above equation for the cross sectional area of the retainer and ensuring a guide clearance reduced due to centrifugal force. In this case, the width of the retainer shrinks to be smaller than that of a conventional corrugate retainer so that a weight of the retainer can be reduced. Therefore, this contributes to suppressing rotational torque and makes it possible to achieve higher speed rotation.

A ball bearing according to a third configuration of the present invention includes: an inner ring; an outer ring; balls as a plurality of rolling elements interposed between the inner ring and the outer ring; and a corrugate retainer of a rolling element-guided type for retaining the balls. In addition, the below equations are satisfied.

$$[ Math 5 ]$$

$$\begin{matrix}Bt \geq \frac{C r}{9} and \\ \frac{( {D}_{1} - {D}_{2} )}{2} - 1 \geq B \geq 2 \times \sqrt{{s}^{2} - {( S - ( H - R ) )}^{2}}\end{matrix}$$

B: width of the retainer
t: thickness of the retainer
Cr: basic dynamic rated load
D₁: inner diameter of the outer ring
D₂: outer diameter of the inner ring
H: depth of the pocket of the corrugate retainer
S: curvature radius of the pocket of the corrugate retainer
R: radius of the ball

According to a rolling element load analysis in which the weight of the retainer is considered, the weight of the retainer prevents the rolling element from being in a condition in the rolling direction. Thus, reducing the weight of the retainer can contribute to suppressing rotational torque.

According to this configuration, in the conventional corrugate retainer, only the width of the retainer shrinks without changing the curvature radius of the pocket and the depth of the pocket. As a result, the weight of the retainer can be reduced without manufacturing a new mold for the corrugate retainer as compared with the conventional corrugate retainer. In addition, it is possible to obtain necessary strength for the corrugate retainer by making a cross sectional area of the retainer greater than a set value. In this configuration, it is also possible to reduce manufacturing costs, to reduce wear and to suppress rotational torque and temperature increase.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views:

FIG. 1 is a longitudinal cross-sectional view of a ball bearing according to a first embodiment of the present invention;

FIG. 2 is a radial cross-sectional view of a retainer of the ball bearing;

FIG. 3 is a circumferential cross-sectional view of the retainer;

FIG. 4 is a schematic diagram that illustrates a radial cross section of a one-sided model of the retainer;

FIG. 5 is a schematic diagram that illustrates a radial cross section of the retainer in a completed condition;

FIG. 6 is a schematic diagram that illustrates a radial cross section wherein a ball is in a pocket space of the retainer;

FIG. 7 is a schematic diagram that illustrates the pocket space;

FIG. 8 illustrates an amount of movement of a ball in a retainer pocket;

FIG. 9 is a cross-sectional view illustrates a schematic configuration of an example of the ball bearing used for industrial machinery;

FIG. 10 a longitudinal cross-sectional view of a rolling bearing according to a second embodiment of the present invention;

FIG. 11 is a perspective view of a corrugate retainer of the rolling bearing;

FIG. 12 illustrates the corrugate retainer from radially outside;

FIG. 13 is a cross-sectional view of the corrugate retainer of FIG. 11 cut at a XIII plane surface;

FIG. 14 is an enlarged view that illustrates a relevant part of the corrugate retainer and a rolling element;

FIG. 15 illustrates the relationship between a pressing load from a rolling element, a rolling element load on an inner ring side and an outer ring side, and a rolling friction coefficient;

FIG. 16 illustrates the relationship between a contact angle of a rolling element, a depth of a pocket, a curvature radius of the pocket, and a radius of a ball;

FIG. 17 a rolling element load analysis of a rolling bearing according to a third embodiment of the present invention wherein a weight of a retainer is considered;

FIG. 18 illustrates a range of a width of a retainer of the rolling bearing;

FIG. 19 illustrates rotational test results for different contact angles of the rolling element; and

FIG. 20 illustrates rotational test results for different retainer band widths.

### DESCRIPTION OF THE EMBODIMENTS

### First Embodiment

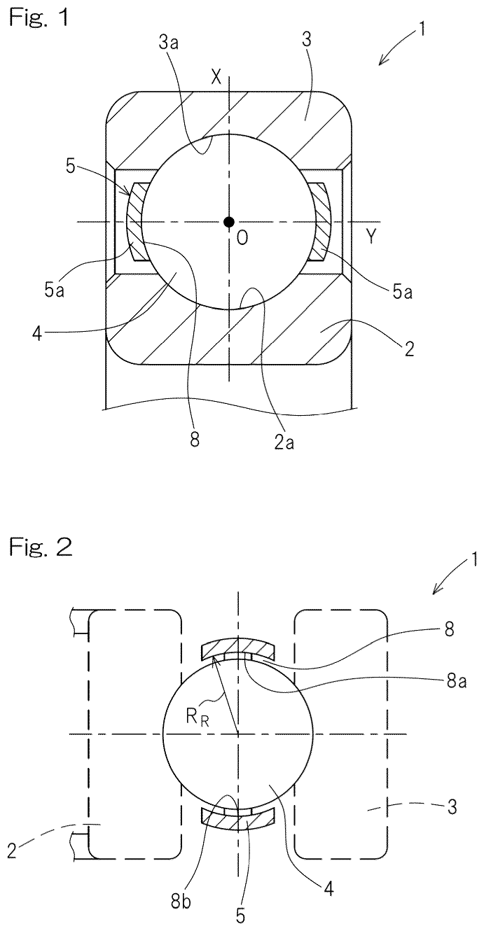

A deep groove ball bearing, which is a ball bearing according to an embodiment of the present invention, is described with reference to FIG. 1 to FIG. 8.

### <Schematic Configuration of Deep Groove Ball Bearing>

FIG. 1 is a longitudinal cross-sectional view of a deep groove ball bearing 1 according to the embodiment cut at a virtual plane passing through an axis of the bearing and a center O of a ball. The deep groove ball bearing 1 is used for industrial machinery such as, for example, an electric motor or a compressor. However, the deep groove ball bearing 1 can be used for applications other than the electric motor or the compressor. The deep groove ball bearing 1 includes an inner ring 2, an outer ring 3, balls 4 which is rolling elements, and a retainer 5 that is of a rolling element guided type. A plurality of balls 4 are interposed between a raceway surface 2a of the inner ring 2 and a raceway surface 3a of the outer ring 3, and are retained by the retainer 5 at fixed intervals in a circumferential direction.

Lubricant such as grease is sealed in a bearing space between the inner ring 2 and the outer ring 3 of FIG. 2. The inner ring 2, the outer ring 3 and the ball 4 are made of, for example, a high carbon chrome bearing steel such as SUJ 2 or martensite based stainless steel or the like. It is to be noted that the present invention is not limited to the use of such specific steel material. In addition, a seal member not illustrated may be attached on the outer ring 3 to seal the bearing space.

### <Retainer>

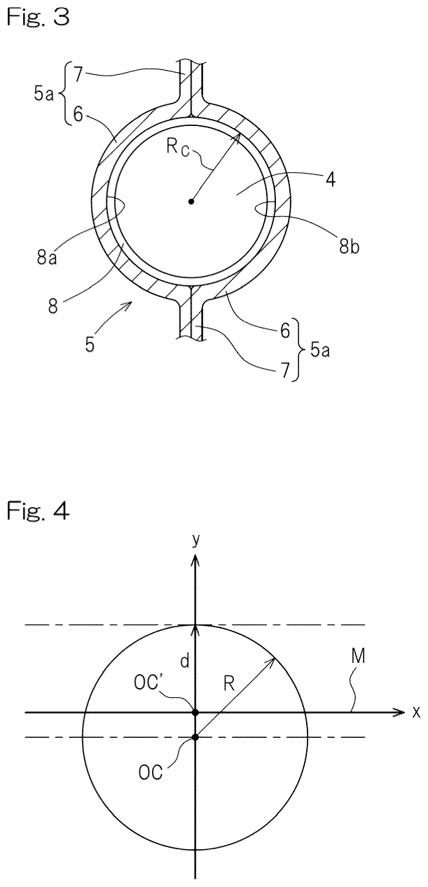

As shown in FIG. 3, the retainer 5 is a corrugate retainer comprised of two annular retainer strips 5a, 5a combined together in an axial direction, each of which has a respective semicircular bulged portion arranged at a predetermined interval from each other along the circumferential direction. In the following description, the corrugate retainer is sometimes referred to simply as a “retainer”. Each of the annular retainer strips 5a has a semicircular bulged portion 6 arranged along the circumferential direction and a flat portion 7 connecting the semicircular bulged portions 6 adjacent in the circumferential direction.

In a state where the annular retainer strips 5a, 5a are combined together, the flat portions 7 are overlapped with each other, and the flat portions 7, 7 are connected together via a rivet or an engaging claw not illustrated. Each of the semicircular bulged portions 6 is opposed to each other so as to form a ring-shaped pocket 8. Each of the pockets 8 holds the ball 4. As shown in FIG. 2 and FIG. 3, a pocket surface 8a is formed of a curved surface such as a spherical surface. In other words, each of cross sections in the circumferential direction (FIG. 3) and a radial direction (FIG. 2) which passes through a deepest portion 8b of the pocket 8 of the retainer 5 is an arc-shaped curved surface. Each of the annular retainer strips 5a of FIG. 3 is, for example, a pressed product made of a steel strip as a cold rolled steel. In this case, the retainer is also referred to a corrugate pressed retainer.

When the deep groove ball bearing is used under an using condition with misalignment, lead-lag of the rolling element is caused. Further, when the allowable amount of movement of the rolling element in the retainer pocket 8 in the circumferential direction is small, interference force between the rolling element and the retainer is large. Accordingly, since repeated stress is applied to a retainer body and the rivet, there is a possibility that a failure such as fatigue breakdown is caused. To avoid the failure, it is necessary to secure the allowable amount of movement of the rolling element in the retainer pocket in the circumferential direction which is sufficient to allow lead-lag of the rolling element caused by misalignment.

<Description about Retainer and Ball Model>

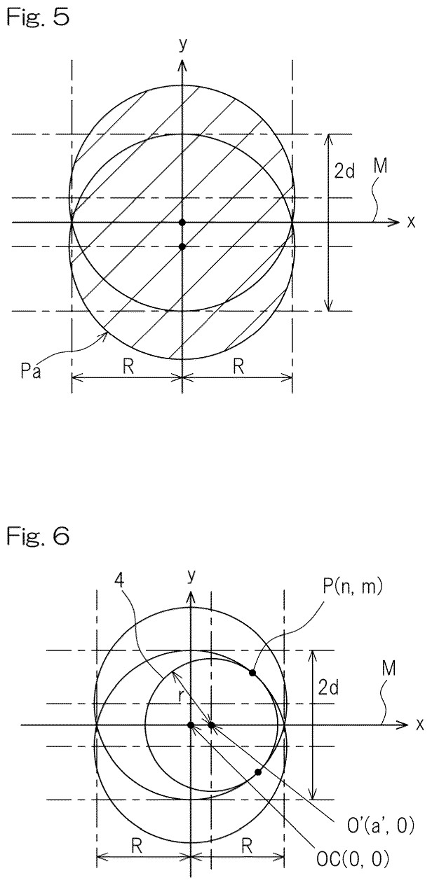

Regarding a single retainer pocket, when a cross section in the radial direction at the center of the pocket is taken into consideration, FIG. 4 can illustrate a pocket on the cross section of the retainer in the radial direction by means of a curvature radius R of the retainer pocket surface in the radial direction and a depth d of the retainer pocket. In FIG. 4 to FIG. 7, “x” represents the radial direction of the bearing, and “y” represents the axial direction of the bearing. Regarding a one-sided model of FIG. 4, the corrugate steel plate retainer in a completed condition is illustrated in FIG. 5 by symmetrically applying a mating surface M of the retainer to an opposite side. In this case, a portion Pa shown by hatching in FIG. 5 corresponds to a pocket space of the retainer. As shown in FIG. 6, the case where the ball 4 having a radius r is placed in the pocket space is considered. In addition, when the ball 4 is moved to an x-axis direction, an outer diameter direction, from a center coordinate OC of the pocket (0,0) and the ball 4 contacts with the pocket at a point P (n. m), a center coordinate O′ (a, 0) can be obtained.

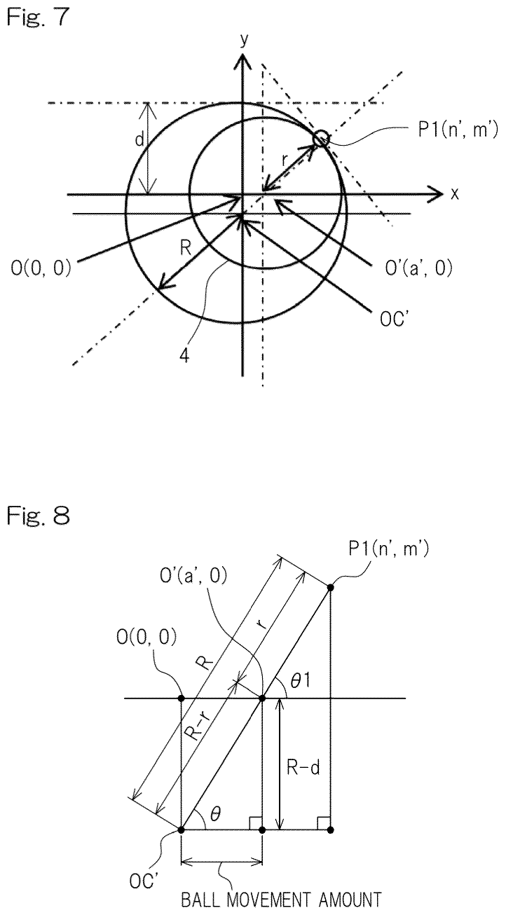

By determining a contact point P, an amount of movement of the ball can be determined when the equation, the retainer width≥the contact point P, is satisfied. The pocket space can be illustrated in FIG. 7.

Since the ball 4 contacts with the pocket at a contact point P1 and they share a tangent line, a normal of the tangent line at the contact point P1 passes through a center O′ of the ball and a center OC′ of the pocket. As for the four elements, an “origin O”, the “center O′ of the ball”, the “center OC′ of the pocket”, and the “contact point P1”, they can be processed within the system of a right-angled triangle of FIG. 8.

An X-coordinate n′ (FIG. 7) of the contact point P1 (FIG. 7) is defined by the following equations.

$$[ Math 6 ]$$

$$\begin{matrix}P ( x , y ) = P ( R cos θ , R sin θ ) \\ cos θ = \frac{\sqrt{{( R - r )}^{2} - {( R - d )}^{2}}}{( R - r )} \\ sin θ = \frac{( R - d )}{( R - r )} \\ P ( x , y ) = P ( \frac{R \sqrt{{( R - r )}^{2} - {( R - d )}^{2}}}{( R - r )} , \frac{R ( R - d )}{( R - r )} )\end{matrix}$$

t: amount of movement of the ball when the ball and the pocket are in this relationship

$$r = \sqrt{{( R - r )}^{2} - {( R - d )}^{2}}$$

A cross section in the circumferential direction which passes through a deepest point (deepest portion) of the retainer pocket and a center point of the retainer pocket surface is considered. The allowable amount of movement of the rolling element in the retainer pocket in the circumferential direction is geometrically determined by Equation (1) defined by a radius r of the rolling element, a curvature radius R_{C} of the retainer pocket surface in the circumferential direction, and a depth d of the retainer pocket. Herein, the “allowable amount of movement of the rolling element in the retainer pocket in the circumferential direction” is an amount of the rolling element in the circumferential direction until the rolling element comes into contact with the retainer pocket surface when the center of the rolling element is on a line connecting the deepest point of the retainer pocket and the center of the retainer pocket surface and the rolling element located at an intermediate position between the retainer pockets on both sides is moved to the circumferential direction.

$$[ Math 7 ]$$

$${Δ}_{C} = \sqrt{{( {R}_{C} - r )}^{2} - {( {R}_{C} - d )}^{2}} \qquad Equation ( 1 )$$

Δ_{C}: allowable amount of movement of the rolling element in the retainer pocket in the circumferential direction
r: radius of the rolling element
R_{C}: curvature radius of the retainer pocket surface in the circumferential direction
d: depth of the retainer pocket

A cross section in the radial direction which passes through the deepest point (deepest portion) of the retainer pocket and the center point of the retainer pocket surface is considered. Regarding the cross section in the radial direction which passes through the center of the retainer pocket, the allowable amount of movement of the rolling element in the retainer pocket in the radial direction is represented by Equation (2).

Herein, the “allowable amount of movement of the rolling element in the retainer pocket in the radial direction” is an amount of the rolling element in the radial direction until the rolling element comes into contact with the retainer pocket surface at an outer side in the radial direction or the retainer pocket surface at an inner side in the radial direction when the center of the rolling element is on a line connecting the deepest point of the retainer pocket and the center of the retainer pocket surface and the rolling element located at an intermediate position between the retainer pockets on both sides is moved to the radial direction.

### [Math 8]

When a contact point between the pocket and the rolling element is located in the retainer pocket surface, the relationship between the retainer and the ball satisfies the equation below.

$$( \frac{{R}_{R} \sqrt{{( {R}_{R} - r )}^{2} - {( {R}_{R} - d )}^{2}}}{( {R}_{R} - r )} ) \leq h$$

In this case, the allowable amount of movement of the rolling element in the retainer pocket in the radial direction is represented by Equation (2).

$${Δ}_{R} = \sqrt{{( {R}_{R} - r )}^{2} - {( {R}_{R} - d )}^{2}} \qquad Equation ( 2 )$$

Δ_{R}: allowable amount of movement of the rolling element in the retainer pocket in the radial direction
r: radius of the rolling element
R_{R}: curvature radius of the retainer pocket surface in the radial direction
d: depth of the retainer pocket
h: width on one side of the retainer, which width is a width from the deepest point of the retainer pocket to the outer or inner edges of the retainer pocket in the radial direction

Incidentally, considering the retainer has an annular shape, the amount of movement of the retainer in the radial direction depends on a minimum one of the allowable amount of movement of the rolling element in the retainer pocket in the circumferential direction and the radial direction. In other words, when the allowable amount of movement of the rolling element in the retainer pocket in the radial direction is smaller than that in the circumferential direction, the amount of movement of the retainer in the radial direction is to be the allowable amount of movement in the radial direction in the pocket at the 0-degree position or the 180-degrees position in the circumferential direction in a side view of the ball bearing.

When the allowable amount of movement of the rolling element in the retainer pocket in the circumferential direction is smaller than that in the radial direction, the amount of movement of the entire retainer in the radial direction is to be the allowable amount of movement in the circumferential direction in at the 90-degrees position or the 270-degrees position in the circumferential direction in a side view of the ball bearing.

In this case where the amount of movement of the retainer in the radial direction is large, collision energy between the retainer and the rolling element due to vibration increases when the ball bearing is used under conditions with vibration and impact. Accordingly, there is a possibility that fatigue breakdown in the retainer body and the rivet may be caused. In addition, there is also a possibility that an instable behavior of the retainer may cause vibration and noise caused by the ball bearing when the ball bearing rotates. Thus, it is favorable to suppress the amount of movement of the retainer in the radial direction.

### <Features of the Pocket>

Considering the above, the following relationship is favorable in order to secure the allowable amount of movement of the rolling element in the retainer pocket in the circumferential direction which is sufficient to allow lead-lag of the rolling element and to suppress the amount of movement of the retainer in the radial direction when misalignment occurs between the inner ring and the outer ring. Namely, it is favorable that the contact point between the pocket and the rolling element on the cross section in the radial direction of the retainer is positioned in the retainer pocket surface (i.e., Equation (3) is satisfied) and the curvature radius of the retainer pocket surface in the radial direction is equal to or less than the curvature radius of the retainer pocket surface in the circumferential direction (i.e., Equation (4) is satisfied).

$$[ Math 9 ]$$

$$( \frac{{{R}_{R} ( {R}_{R} - r )}^{2} - {( {R}_{R} - d )}^{2}}{( {R}_{R} - r )} ) \leq h \qquad Equation ( 3 )$$

$${R}_{R} \leq {R}_{C} \qquad Equation ( 4 )$$

r: radius of the rolling element
R_{C}: curvature radius of the retainer pocket surface in the circumferential direction
R_{R}: curvature radius of the retainer pocket surface in the radial direction
d: depth of the retainer pocket
h: width on one side of the retainer, which width is a width from the deepest point of the retainer pocket to the outer or inner edges of the retainer pocket in the radial direction

### <Comparison Between the Present Application and Patent Document 1>

A ball bearing disclosed in Patent Document 1 has a retainer of a bearing ring guided type. When a diameter guide clearance between a retainer and a bearing ring is referred to Cg and a maximum displacement in a radial direction of a rolling element in a pocket is referred to dr, one of the constituent features of Patent Document 1, Cg<δr, is satisfied so that the retainer is guided to an outer peripheral surface of an inner ring groove shoulder or an inner peripheral surface of an outer ring groove shoulder. In contrast, the ball bearing of the present application is different from the ball bearing disclosed in Patent Document 1 in having the retainer that is of the rolling element guided type.

### <Comparison Between the Present Application and Patent Document 2>

A ball bearing disclosed in Patent Document 2 has a feature of a cylindrical surface of a portion in contact with a pocket surface of a retainer and a surface of a rolling element.

In contrast, the ball bearing of the present application is different from the ball bearing disclosed in Patent Document 2 in the retainer pocket surface having a curved surface.

### Effects and Advantages

According to the deep groove ball bearing 1 of FIG. 1 described above, the contact point between the pocket 8 and the rolling element 4 on the cross section in the radial direction of the retainer 5 of the rolling element guided type is positioned in the retainer pocket surface. In addition, the curvature radius of the retainer pocket surface in the radial direction is equal to or less than the curvature radius of the retainer pocket surface in the circumferential direction. Accordingly, even when misalignment occurs between the inner ring 2 and the outer ring 3, it is possible to secure the allowable amount of movement of the ball 4 in the retainer pocket 8 in the circumferential direction which is sufficient to allow lead-lag of the ball 4 and to suppress the amount of movement in the radial direction of the retainer 5. Therefore, it is possible to relax interference force between the retainer 5 and the ball 4 due to lead-lag of the rolling element caused by misalignment between the inner ring 2 and the outer ring 3 and to stabilize a behavior of the retainer 5.

By satisfying above Equation (4) and Equation (5), it is possible to relax interference force between the retainer 5 and the ball 4 due to lead-lag of the rolling element caused by misalignment and to reduce repeated stress applied to the retainer body and the rivet due to a collision between the retainer 5 and the ball 4. This can suppress malfunction of the retainer 5 and prevent vibration and noise caused by an instable behavior of the retainer 5. In addition, it is possible to provide the deep groove ball bearing 1 having the retainer 5 having high reliability without a risk of excessive friction, wear and heating due to a slide between the retainer 5 and a guide surface of the bearing ring.

### <Example Use of the Ball Bearing>

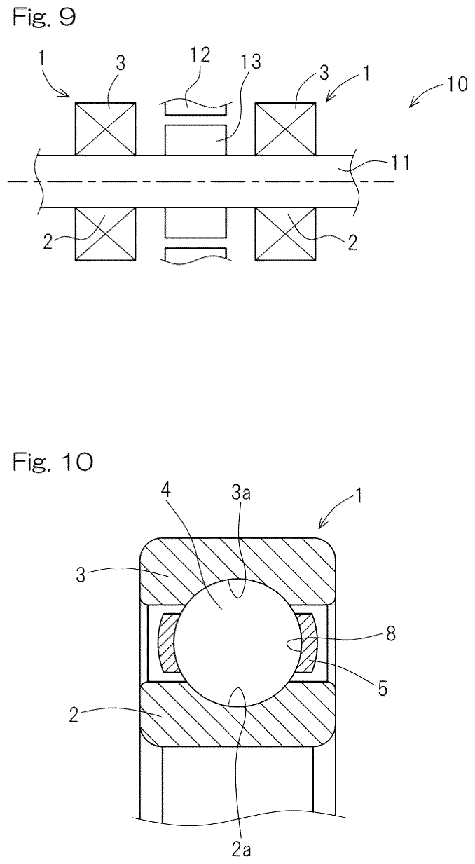

As shown in FIG. 9, the deep groove ball bearing 1 is used for, for example, an electric motor 10. The outer rings 3, 3 are fixed to a housing, which is not illustrated, of the electric motor 10 at a predetermined interval, and an output shaft 11 of the electric motor 10 is fitted and fixed to the inner rings 2 which are rotating rings. A stator 12 having an annular shape is fixed to the housing, and a rotor 13 facing the stator 12 via a gap in the radial direction is fitted and fixed to the output shaft 11. In the electric motor 10, the deep groove ball bearing 1 having high reliability that generates less vibration and noise can be applied.

### OTHER EMBODIMENTS

In the following description, the same reference numerals are used to denote parts that correspond to those previously described in the respective embodiments, and overlapping description is omitted. Where only a part of a configuration is described, the rest of the configuration is to be construed as being the same as the previously described embodiments unless otherwise indicated. The same configurations provide the same effects. It is possible not only to combine the parts that have been particularly described in the respective embodiments but also to partly combine the embodiments unless there is any hindrance to such a combination.

### Second Embodiment

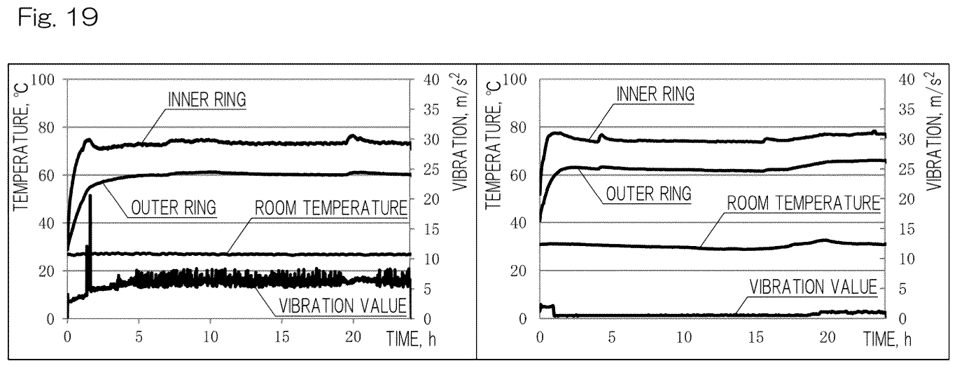

A rolling bearing according to a second embodiment of the present invention is described with reference to FIG. 10 to FIG. 16, and FIG. 19. The rolling bearing (ball bearing) according to this embodiment is used for industrial machinery such as, for example, a servo motor or a generator. However, the deep groove ball bearing can be used for applications other than the servo motor.

### <Schematic Configuration of Rolling Bearing>

As shown in FIG. 10, the deep groove ball bearing 1 according to the second embodiment has the same schematic configuration as the deep groove ball bearing according to the first embodiment described above. In the second embodiment, the common reference numerals are used for the same features as in the first embodiment, and the detailed description is omitted.

### <Retainer>

As shown in FIG. 11, in the retainer 5, the annular retainer strips 5a, 5a are combined together, the flat portions 7 are overlapped with each other, and the flat portions 7, 7 are connected together via a rivet Rb or an engaging claw not illustrated.

### <Regarding Curvature Radius of Pocket, Depth of Pocket, and Width of Retainer>

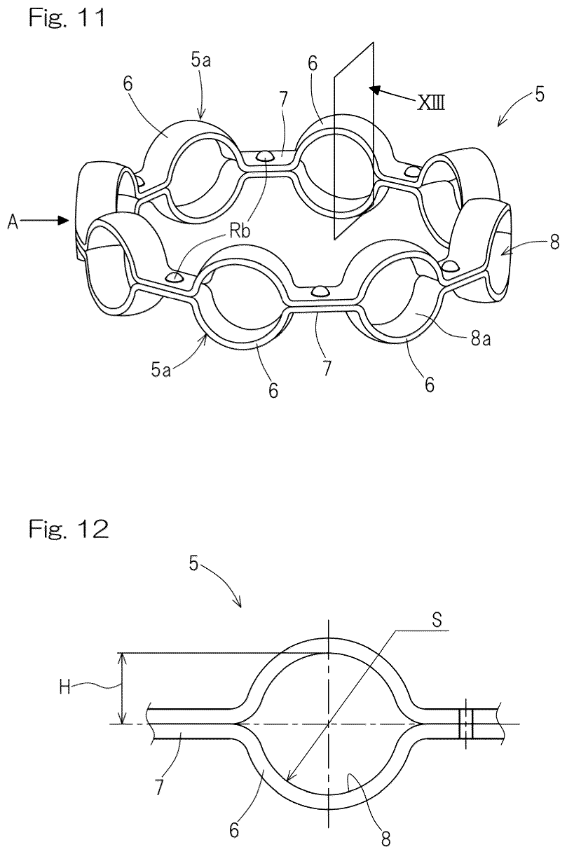

In this embodiment, improving the pocket shape of the retainer 5, makes it possible to suppress sliding wear between the rolling element and the pocket and temperature increase during bearing rotation, thereby achieving higher speed rotation equivalent to that of a resin retainer. FIG. 12 illustrates the corrugate retainer 5 from radially outside (from the arrow A in FIG. 11).

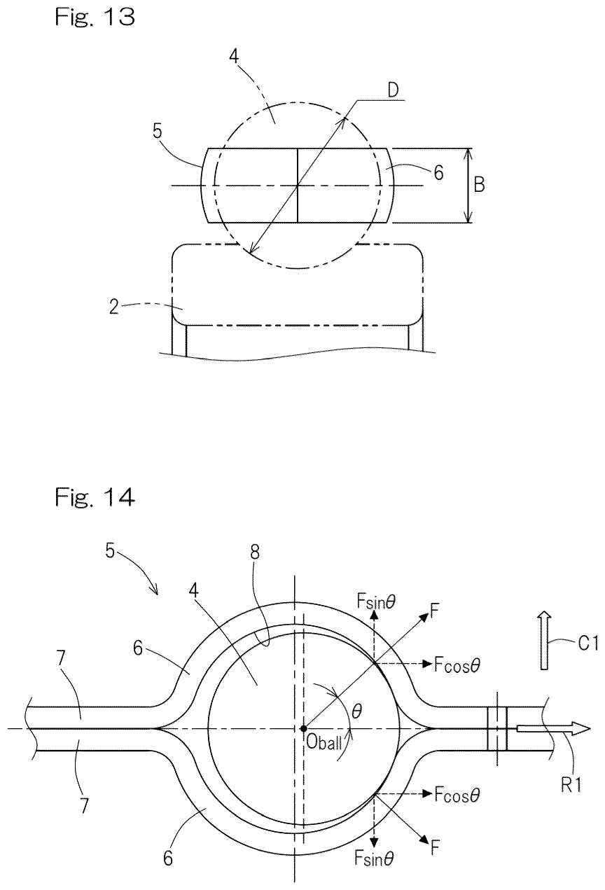

As a feature of this embodiment, a curvature radius S of the pocket, a depth H of the pocket, and a width B of the retainer shown in FIG. 13 are improved as described in (1) and (2) below to make it possible to determine the pocket shape.

### (1) Curvature Radius of Pocket and Depth of Pocket

As shown in FIG. 12, by setting the curvature radius S of the pocket and the depth H of the pocket to optimize a contact angle θ between the pocket 8 and the rolling element 4 (FIG. 10), it is possible to suppress sliding wear. The depth H of the pocket is an axial depth from the center of the pocket to the deepest position of the semicircular bulged portion 6.

### (2) Width of Retainer

As shown in FIG. 13, while necessary strength for the retainer 5 is secured, making the width B of the retainer shorter than that of the conventional structure contributes to suppressing rotational torque and temperature increase. The width B of the retainer is a width dimension of the semicircular bulged portion 6. A method for shortening the width B of the retainer is, for example, to increase an inner diameter of the retainer and to decrease an outer diameter of the retainer as compared with the conventional structure.

### <Load Analysis>

As shown in FIG. 14, the retainer 5 is pressed to the rolling element 4, and rotates in a rotational direction R1. A rotational component force of the retainer rotation of a pressing load F is a retainer guide load. When an angle that comes into contact with the retainer pocket 8 of the rolling element 4 is defined as a contact angle θ, the retainer guide load is 2F cos θ. A component force in the axial direction of the pressing load F is a load to open the retainer 5 held by a tack to a axial direction C1. The magnitude of the load is 2F sin θ.

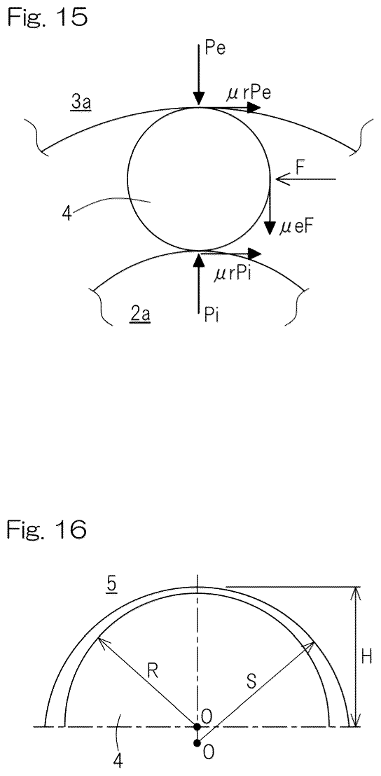

As shown in FIG. 15, during bearing rotation, the pressing load F from the rolling element 4 to the corrugate retainer is determined by a rolling element load and a rolling friction coefficient. The pressing load F is defined as F=2μᵣPᵢ/(1+μ_{c}). Regarding a numerator of the above equation, it is considered that an equation, Pₑ≅Pᵢ, is established, and therefore, μᵣPₑ+μᵣPᵢ is construed as 2μᵣPᵢ. The pressing load F is constant unless the use condition is changed. In FIG. 15, Pₑ is a rolling element load on an outer ring side, and Pᵢ is a rolling element load on an inner ring side. In addition, μᵣ is a rolling friction coefficient between the rolling element and the bearing ring, and μ_{c} is a rolling friction coefficient between the retainer and the rolling element. However, the weight of the retainer is not considered.

According to the above load analysis, for the same bearing under the similar use condition, the pressing force from the rolling element 4 to the retainer is constant. Therefore, the contact angle θ between the rolling element 4 and the pocket 8 shown in FIG. 14 is the only factor to distribute the pressing load F to a driving force F cos θ of the retainer 5 and a load F sin θ in the axial direction C1.

When the corrugate retainer 5 receives a guide load F cos θ in the rotational direction R1 from the rolling element 4, the retainer 5 and the rolling element 4 rotate together. Since the retainer 5 cannot be freed to the axial direction C1 from the load F sin θ in the axial direction C1 from the rolling element 4, the retainer 5 wears significantly. Therefore, the load F sin θ in the axial direction C1 is a main cause of pocket wear. To reduce pocket wear, the pocket shape of the retainer 5 is optimized so that the contact angle θ is less than 45 degrees to lessen the load F sin θ in the axial direction.

To make the contact angle θ less than 45 degrees, as shown in FIG. 16, the following equation with respect to the curvature radius S of the pocket and the depth H of the pocket is satisfied.

$$[ Math 10 ]$$

$$sin θ = \frac{( S - H ) \times ( R \times S )}{( {S}^{2} - {R}^{2} )} < sin 45 ° = \frac{\sqrt{2}}{2} \qquad Equation ( 1 )$$

H: depth of the pocket of the corrugate retainer
S: curvature radius of the pocket of the corrugate retainer
R: radius of the ball

### <Rotational Test>

Rotational tests were conducted for a deep groove ball bearing having a corrugate steel plate retainer in an example whose contact angle θ with the retainer pocket of the rolling element is less than 45 degrees (specifically, 0=) 35° and a deep groove ball bearing having a corrugate steel plate retainer in a comparative example whose contact angle θ with the retainer pocket of the rolling element is more than 45 degrees (specifically, 0=) 65°. In the rotational tests, a deep groove ball bearing, whose bearing number is 6330, used for an actual servomotor and generator with medium- or high-speed rotation was employed. The tests were conducted with an inner rotating at a constant rotational speed, satisfying the following use conditions: dn value (calculated by multiplying an inner diameter of an inner ring by the number of rotation)=400,000, grease lubrication, radial load=16.4 kN, axial load=2.9 kN, rotation time=24 hours, the above dn value=400,000.

During the rotational tests, temperature of the inner ring and the outer ring was measured at all times by a temperature detector such as a temperature sensor, and vibration was also measured at all times by a vibration detector disposed at, for example, the housing supporting the outer ring. After a lapse of a certain specified time, each bearing was disassembled, and it was visually confirmed whether or not pocket wear occurred.

The comparative example indicated on the left side of FIG. 19 shows pocket wear occurred and vibration during rotation was larger than that of the example indicated on the right side of FIG. 19. In the example, pocket wear did not occur and temperature rising was about 3° C. lower than that in the comparative example. The test results are summarized in Table 1.

TABLE 1

| | Comparative | |
|---|---|---|
| | Example | Example |
| Pocket Wear | Acceptable | Good |
| Temperature Rising of Inner and | Acceptable | Good |
| Outer Rings relative to Room | | |
| Temperature | | |
| Vibration | Poor | Good |

In Table 1, “Good” indicates being very good, “Acceptable” indicates being less than “Good”, but acceptable for use, and “Poor” indicates being bad. In the example, when the contact angle θ is less than 45 degrees, pocket wear did not occur, and it was possible to suppress temperature increase as compared with the comparative example. In the comparative example, when the contact angle θ is 45 degrees or more, pocket wear occurred, and vibration during rotation was stronger as than that in the example.

### Effects and Advantages

According to the deep groove ball bearing 1 of FIG. 10 described above, it is possible to obtain the above advantageous effects by only optimizing the pocket shape of the retainer 5. Therefore, as compared with the conventional technology in which the resin coating film is formed on a pocket surface, it is possible to reduce manufacturing costs, to reduce wear and to suppress rotational torque and temperature increase. It is possible to obtain necessary strength for the corrugate retainer 5 by making a cross sectional area of the retainer calculated by multiplying a width of the retainer by a thickness of the retainer greater than a value calculated by dividing a basic dynamic load by 9.

On the premise of satisfying the above equation for the cross sectional area of the retainer and ensuring a guide clearance reduced due to centrifugal force, the width of the retainer shrinks to be smaller than that of a conventional corrugate retainer so that a weight of the retainer can be reduced. Therefore, this contributes to suppressing rotational torque and makes it possible to achieve higher speed rotation.

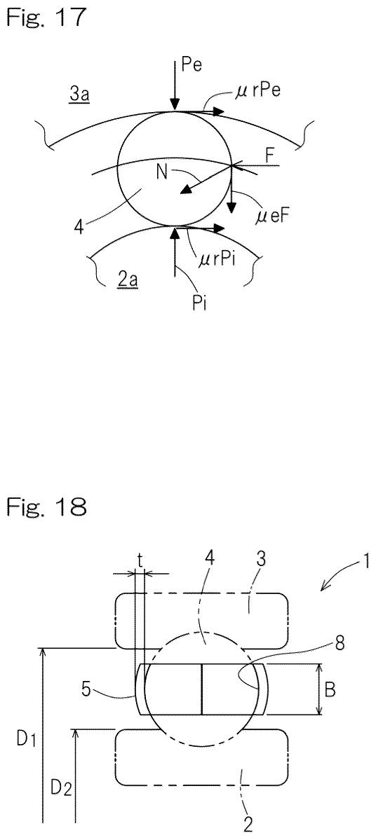

### Third Embodiment: Setting of Width of Retainer, FIGS. 17, 18 and 20

In a rolling bearing (ball bearing) according to a third embodiment, the width of the retainer is set within a set range. The rolling bearing has the same schematic configuration as the rolling bearing of FIG. 10 described above.

### <Load Analysis>

As shown in FIG. 17, according to a rolling element load analysis in which the weight of the retainer is considered, the weight of the retainer prevents the rolling element 4 from being in a condition in the rolling direction. Thus, reducing the weight of the retainer contributes to suppressing rotational torque. In FIG. 17, Pₑ is a rolling element load on an outer ring side, and Pᵢ is a rolling element load on an inner ring side. In addition, μᵣ is a rolling friction coefficient between the rolling element 4 and the bearing ring, and μ_{c} is a rolling friction coefficient between the retainer and the rolling element 4. N is a load received by the rolling element 4 due to the weight of the retainer.

In a rolling bearing 1 of FIG. 18 according to this embodiment, in the conventional retainer, only the width B of the retainer shrinks without changing the curvature radius of the pocket and the depth of the pocket. As a result, the weight of the retainer can be reduced without manufacturing a new mold for the retainer as compared with the conventional retainer. If the retainer is a corrugate steel plate retainer, calculations are performed to derive equations under the following conditions (1) to (4) to obtain necessary strength.
(1) The maximum radial load received by the deep groove bearing is 10% of a bearing dynamic rated load.
(2) A sliding friction coefficient between the rolling element and the inner and outer rings in starting an operation of the bearing is 0.15.
(3) A tensile strength of the corrugate steel plate retainer is 270 MPa.
(4) A cross sectional area of the retainer is calculated by multiplying the width B of the retainer by a thickness t of the retainer, i.e., B×t.

Equation (2) below should be satisfied.

A pressing force from the ball, that is the rolling element, to the retainer: 0.1Cr (basic dynamic rated load)×0.15 (sliding friction coefficient)

Retainer stress due to pressing: 0.1Cr (basic dynamic rated load)×0.15 (sliding friction coefficient)/Bt

Retainer stress due to pressing<0.5×270 MPa (tensile strength of the corrugate steel plate retainer)=135 MPa

$$\to Bt \geq ( Cr / 9 ) \qquad Equation ( 2 )$$

Note: Cr (unit: kN), B, t (unit: mm)

The width B of the retainer is set within the following range on the premise of satisfying above Equation (2) and ensuring a guide clearance reduced due to centrifugal force.

$$[ Math 11 ]$$

$$\frac{( {D}_{1} - {D}_{2} )}{2} - 1 \geq B \geq 2 \times \sqrt{{S}^{2} - {( S - ( H - R ) )}^{2}} \qquad Equation ( 3 )$$

D₁: inner diameter of the outer ring
D₂: outer diameter of the inner ring
B: width of the retainer
H: depth of the pocket of the corrugate retainer
S: curvature radius of the pocket of the corrugate retainer
R: radius of the ball
Unit (mm)

### <Rotational Test>

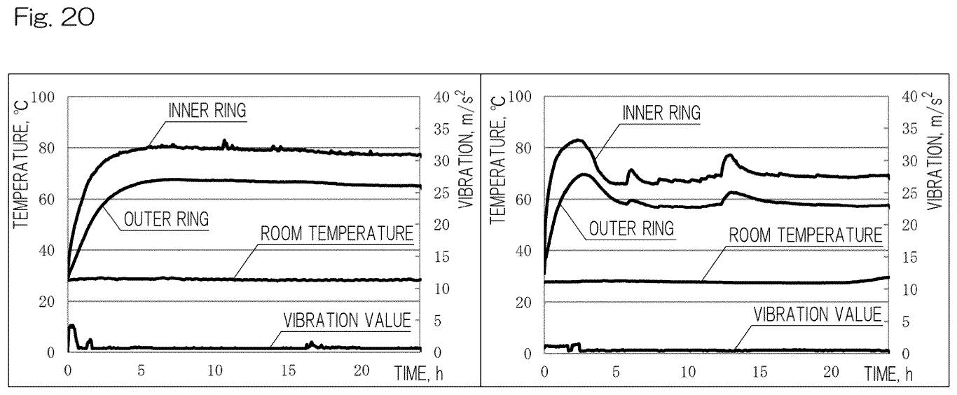

Similar rotational tests as described above in which only the width of the retainer is different were conducted. The comparative example indicated on the left side of FIG. 20 is a deep groove ball bearing having a conventional corrugate steel plate retainer in which Equation (3) is not satisfied. On the other hand, the example indicated on the right side of FIG. 20 is a deep groove ball bearing having a corrugate steel plate retainer in which Equation (2) and Equation (3) are satisfied. In the rotational tests, a deep groove ball bearing, whose bearing number is 6330, used for an actual servomotor and generator with medium- or high-speed rotation was employed. The tests were conducted with an inner rotating at a constant rotational speed, satisfying the following use conditions: dn value (calculated by multiplying an inner diameter of an inner ring by the number of rotation)=525,000, grease lubrication, radial load=16.4 kN, axial load=2.9 kN, the above dn value=525,000.

During the rotational tests, temperature of the inner ring and the outer ring was measured at all times by a temperature detector such as a temperature sensor, and vibration was also measured at all times by a vibration detector disposed at, for example, the housing supporting the outer ring. After a lapse of a certain specified time, each bearing was disassembled, and it was visually confirmed whether or not pocket wear occurred.

The comparative example indicated on the left side of FIG. 20 shows pocket wear did not occur. In the example on the right side of FIG. 20, pocket wear did not occur and temperature rising was about 10° C. lower than that in the comparative example. The test results are summarized in Table 2.

TABLE 2

| | Comparative | |
|---|---|---|
| | Example | Example |
| Pocket Wear | Good | Good |
| Temperature Rising of Inner and | Poor | Good |
| Outer Rings relative to Room | | |
| Temperature | | |
| Vibration | Good | Good |

In Table 2, “Good” indicates being very good, and “Poor” indicates being bad.

According to this configuration, in the conventional corrugate retainer, only the width B of the retainer of FIG. 18 shrinks to a certain specified range without changing the curvature radius of the pocket and the depth of the pocket. As a result, the weight of the retainer can be reduced without manufacturing a new mold for the corrugate retainer as compared with the conventional corrugate retainer. In addition, it is possible to obtain necessary strength for the corrugate retainer 5 by making a cross sectional area Bt of the retainer greater than a set value. In this configuration, it is also possible to reduce manufacturing costs, to reduce wear and to suppress rotational torque and temperature increase.

In the deep groove ball bearing, a seal member not illustrated may be attached on only one side to seal the bearing space.

Lubricant oil other than grease may be used as lubricant in the deep groove ball bearing.

While preferred embodiments have been described thus far with reference to the drawings, various additions, modifications, or omissions can be made therein without departing from the principle of the present invention and are, thus, encompassed within the scope of the present invention.

### REFERENCE SYMBOLS

1 . . . deep groove ball bearing (ball bearing)
2 . . . inner ring
3 . . . outer ring
4 . . . ball (rolling element)
5 . . . retainer
8 . . . pocket

What is claimed is:

1. A ball bearing comprising:
an inner ring;
an outer ring;
rolling elements interposed between the inner ring and the outer ring; and
a corrugate retainer which retains the rolling elements, wherein
each of cross sections in a circumferential direction and a radial direction which passes through the deepest portion of a pocket of the retainer is an arc-shaped curved surface,
a contact point between the pocket and the rolling element on the cross section in the radial direction of the retainer is positioned in a retainer pocket surface, and
a curvature radius of the retainer pocket surface in the radial direction is equal to or less than a curvature radius of the retainer pocket surface in the circumferential direction.

2. The ball bearing as claimed in claim 1, wherein, for the retainer and the rolling element, the equations below are satisfied.
$$\begin{matrix}( \frac{{R}_{R} \sqrt{{( {R}_{R} - r )}^{2} - {( {R}_{R} - d )}^{2}}}{( {R}_{r} - r )} ) \leq h \\ {R}_{R} \leq {R}_{C}\end{matrix} \qquad [ Math 12 ]$$
r: radius of the rolling element
R_{C}: curvature radius of the retainer pocket surface in the circumferential direction
R_{R}: curvature radius of the retainer pocket surface in the radial direction
d: depth of the retainer pocket
h: width on one side of the retainer, which is a width from the deepest point of the retainer pocket to the outer or inner edges of the retainer pocket at an inner side in the radial direction

3. The ball bearing as claimed in claim 1, wherein the ball bearing is a deep groove ball bearing used for industrial machinery.

4. A ball bearing comprising:
an inner ring;
an outer ring;
balls, which are rolling elements, interposed between the inner ring and the outer ring; and
a corrugate retainer which retains the balls, wherein
the below expression is satisfied.
$$\frac{( S - H ) \times ( R + S )}{( {S}^{2} - {R}^{2} )} < \frac{\sqrt{2}}{2} \qquad [ Math 13 ]$$
H: depth of pocket of the corrugate retainer
S: curvature radius of pocket of the corrugate retainer
R: radius of the ball

5. The ball bearing as claimed in claim 4, wherein the corrugate retainer satisfies the equation below.
$$Bt \geq \frac{Cr}{9} \qquad [ Math 14 ]$$
B: width of the retainer
t: thickness of the retainer
Cr: basic dynamic rated load

6. The ball bearing as claimed in claim 5, wherein the corrugate retainer satisfies the equation below.
$$\frac{( {D}_{1} - {D}_{2} )}{2} - 1 \geq B \geq 2 \times \sqrt{{S}^{2} - {( S - ( H - R ) )}^{2}} \qquad [ Math 15 ]$$
D₁: inner diameter of the outer ring
D₂: outer diameter of the inner ring
B: width of the retainer
H: depth of the pocket of the corrugate retainer
S: curvature radius of the pocket of the corrugate retainer
R: radius of the ball

7. A ball bearing comprising:
an inner ring;
an outer ring;
balls, which are rolling elements, interposed between the inner ring and the outer ring; and
a corrugate retainer which retains the balls, wherein
the below equations are satisfied.
$$Bt \geq \frac{Cr}{9} and \qquad [ Math 16 ]$$
$$\frac{( {D}_{1} - {D}_{2} )}{2} - 1 \geq B \geq 2 \times \sqrt{{s}^{2} - {( S - ( H - R ) )}^{2}}$$
B: width of the retainer
t: thickness of the retainer
Cr: basic dynamic rated load
D₁: inner diameter of the outer ring
D₂: outer diameter of the inner ring
H: depth of the pocket of the corrugate retainer
S: curvature radius of the pocket of the corrugate retainer
R: radius of the ball
